(19) United States
(12) Patent Application Publication
(10) Pub. No.: US 2011/0049213 A1
(43) Pub. Date: Mar. 3, 2011

(54) STAPLER

(75) Inventors: Thomas Schneider, Leonberg (DE); Ulrich Schneider, Stuttgart (DE); Kurt Leute, Blumberg (DE)

(73) Assignee: Esselte Leitz GmbH & Co KG, Stuttgart (DE)

(21) Appl. No.: 12/736,035

(22) PCT Filed: Feb. 16, 2009
(86) PCT No.: PCT/EP2009/051777

§ 371 Date: Sep. 17, 2010

(30) Foreign Application Priority Data
Mar. 4, 2008 (DE) 10 2008 012 511.3

(51) Int. Cl. B27F 7/00

(52) U.S. Cl. 227/120

(57) ABSTRACT

The invention relates to a stapling device (10) comprising: an anvil arm (12) which in its front region bears an anvil plate (14) on which documents can be placed; a staple magazine (20) which can be pivoted to a limited extent about a transverse pivot (18) on a bearing block (16) in the rearward region of the anvil arm (12); and a driver arm (22) which bears a driver for feeding the staples through a staple discharge slot (26) at the front end of the staple magazine (20) and which can be pivoted to a limited extent about the transverse pivot (18) with respect to the staple magazine (20) and the anvil arm (12), wherein the staple discharge slot (26) extends transversely through a bottom wall (24) of the staple magazine (20) between the magazine side walls (30) which run from the front end towards the bearing block (16) and is bounded with respect to the magazine front end by a stop plate (28) for the staples. According to the invention, the staple discharge slot (26) is closed with respect to the side walls (30) of the staple magazine (20), the staple magazine (20) is provided on each of its side walls (30) with a prong (32) which projects from the bottom wall (24), and the prongs (32) are arranged on both sides of the staple discharge slot (26).

The invention relates to a stapler in accordance with the preamble of claim 1.

Staplers of this type serve to staple together multiple sheets of documents, using a staple. For this purpose, a staple strip composed of a plurality of staples is accommodated in the staple magazine, and this strip is pressed against the stop plate under spring support. The stop plate delimits a staple exit slot toward the front end of the staple magazine, through which the frontmost staple, in each instance, is passed by means of power applied by the driver, when the driver arm and the staple magazine are pressed down. The staple passes through the documents with its staple arms and is deformed in a deformation contour in the anvil plate. The staple exit slot extends transversely through a bottom wall of the staple magazine, and has a width, in this direction, that approximately corresponds to the width of a staple, measured from one staple arm to the other staple arm. The staple exit slot extends not only transversely over the bottom wall, but also a little farther upward, laterally through the side walls. In this region, the side walls do not form a guide for the staple arms, so that these can easily bend in an undesirable direction in the event of non-symmetrical stress or if slight deformation of the staple is already present. In particular, an unintentional movement of the document that is lying on the anvil plate during the stapling process, for example if the user is in a hurry and pulls on the document, can promote this undesirable deformation of the staple, particularly if the stapler is being held in the user's hand during the stapling process. Undesirable mis-stapling results from such staple deformations.

It is therefore the task of the invention to further develop a stapler of the type stated initially, in such a manner that the risk of mis-stapling is reduced.

This task is accomplished, according to the invention, by means of a stapler having the characteristics of claim 1. Advantageous further developments are the object of the dependent claims.

By means of the combination of characteristics according to the invention, multiple complementary advantages are achieved at the same time. For one thing, better guidance of the staples is achieved, in that the staple exit slot is closed toward the side walls of the staple magazine. By means of this measure alone, the staple arms are guided by the side walls of the staple magazine, all the way to their lower end. Since the prongs are disposed on both sides of the staple exit slot, side guidance of the staple arms is extended somewhat further downward, toward the anvil plate. The prongs furthermore hold the document that is lying on the anvil plate in place, as soon as the staple magazine is pressed onto the document, so that it cannot slip as easily with regard to the staple exit slot.

Particularly good additional guidance by the prongs is achieved if their inner surfaces, which face one another, align with a delimitation surface that delimits the staple exit slot, in each instance. In this connection, it is preferred if the inner prong surfaces have a distance from one another that essentially corresponds to the width of a staple, measured between the outer sides of the staple arms that face away from one another. In this case, the staple arms slide along the delimitation surfaces during stapling, and are guided by them and laterally stabilized.

It is practical if the prongs come to a point in the direction toward the anvil arm. They can then easily be pressed into the document to a slight extent, and hold it in place. In this connection, it is preferred that the prongs have a triangular cross-section in the direction transverse to the longitudinal sides of the staple magazine.

According to an advantageous embodiment, the staple magazine is configured as a bent part made of sheet metal, having a stop plate formed on in one piece. In this connection, it is preferred that the prongs are disposed in one piece on the side walls of the staple magazine. However, it is also possible that the staple magazine has a magazine head that has the stop plate and the prongs and is connected with the side walls, which head closes the staple exit slot off at the sides. The magazine head is then connected with the side walls of the staple magazine, as an additional component of the latter, for example welded onto it.

In the following, the invention will be explained in greater detail using an exemplary embodiment shown schematically in the drawing. This shows:

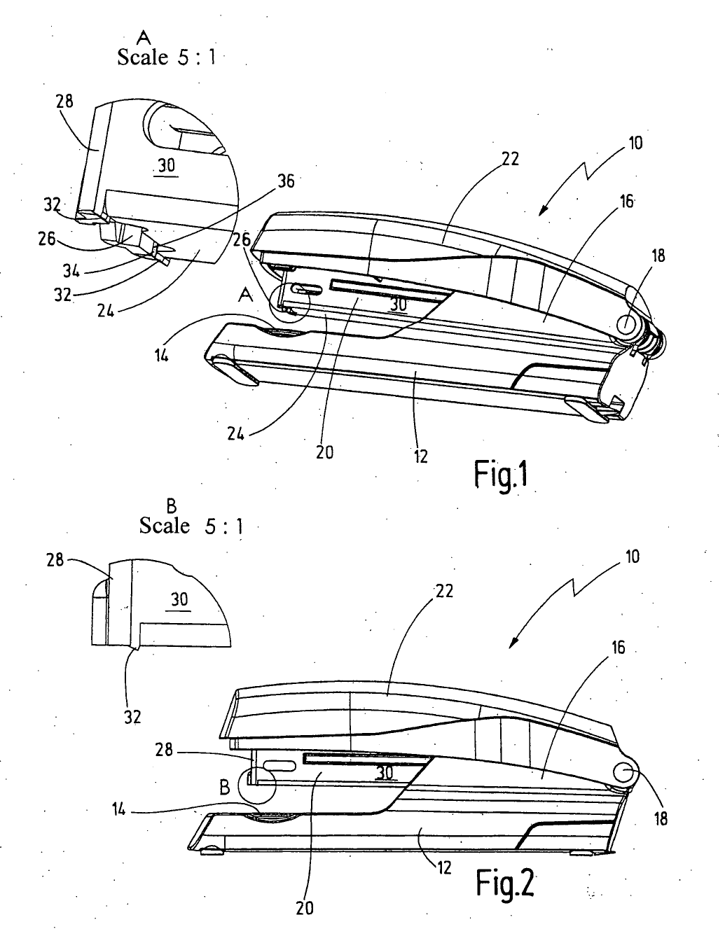

FIG. 1 a stapler in a perspective view, at a slant from below, with an enlarged Detail A, and

FIG. 2 the stapler according to FIG. 1 in a side view, with an enlarged Detail B.

The stapler 10 shown in the drawing has an anvil arm 12, in the front region of which an anvil plate 14 is disposed at its top. In its rear region, the anvil arm 12 has a bearing block 16, in which a transverse axis 18 is mounted, about which a staple magazine 20 can be pivoted, in limited manner, relative to the anvil arm 12. A driver arm 22 is mounted in the bearing block 16, so as to pivot about the transverse axis 18, relative to the anvil arm 12 and the staple magazine 20, and has a plastic cover that serves as a hand lever and a driver for applying force to staples accommodated in the staple magazine 20.

In order to pass through the frontmost staple, in each instance, accommodated in the staple magazine 20, by means of applying force by the driver, the staple magazine 20 has a staple exit slot 26 in its bottom wall 24. This slot is delimited, toward the front end of the staple magazine 20, by a stop plate 28 against which the frontmost staple is pressed, with spring support. On its narrow sides, the staple exit slot 26 is delimited by side walls 30 of the staple magazine 20, which extend from the front end all the way to the bearing block 16. The width of the staple exit slot 26, measured between the side walls 30, approximately corresponds to the width of the staples, measured between the outsides of their staple arms, so that the staples just fit through the staple exit slot 26. On the side walls 30, prongs 32 are formed on, in one piece, which have a triangular cross-section in a viewing direction perpendicular to the side walls 30, and come to a point at the bottom. The prongs are disposed on both sides of the staple exit slot 26, and extend slightly further downward toward the anvil arm 12. Their inside surfaces 34, which face one another, align with the delimitation surfaces 36 of the staple exit slot, so that they form an additional guide for the staples exiting from the staple exit slot 26. Furthermore, they improve the clamping effect on the documents clamped between the anvil plate 14 and the staple magazine 20 when the driver arm 22 is pressed down.

In summary, the following should be stated:

The invention relates to a stapler 10 having an anvil arm 12 that carries an anvil plate 14 in its front region, onto which documents can be placed, having a staple magazine 20 that can be pivoted, in limited manner, on a bearing block 16 in the rear region of the anvil arm 12, about a transverse axis 18, and having a driver arm 22 that can be pivoted, in limited manner, about the transverse axis 18, relative to the staple magazine 20 and the anvil arm 12, which carries a driver to pass the staples through a staple exit slot 26 at the front end of the staple magazine 20, whereby the staple exit slot 26 extends transversely through a bottom wall 24 of the staple magazine 20, between its side walls 30, which run from the front end in the direction toward the bearing block 16, and is delimited, toward its front end, by a stop plate 28 for the staples. According to the invention, it is provided that the staple exit slot 26 is closed toward the side walls 30 of the staple magazine 20, that the staple magazine 20 has a prong 32 projecting from the bottom wall 24, at its side walls 30, in each instance, and that the prongs 32 are disposed on both sides of the staple exit slot 26.

1. Stapler having an anvil arm (12) that carries an anvil plate (14) in its front region, onto which documents can be placed, having a staple magazine (20) that can be pivoted, in limited manner, on a bearing block (16) in the rear region of the anvil arm (12), about a transverse axis (18), and having a driver arm (22) that can be pivoted, in limited manner, about the transverse axis (18), relative to the staple magazine (20) and the anvil arm (12), which carries a driver to pass the staples through a staple exit slot (26) at the front end of the staple magazine (20), whereby the staple exit slot (26) extends transversely through a bottom wall (24) of the staple magazine (20), between its side walls (30), which run from the front end in the direction toward the bearing block (16), and is delimited, toward its front end, by a stop plate (28) for the staples, wherein the staple exit slot (26) is closed toward the side walls (30) of the staple magazine (20), wherein the staple magazine (20) has a prong (32) projecting from the bottom wall (24), at its side walls (30), in each instance, and tapered in the direction toward the anvil arm (12), and wherein the prongs (32) are disposed on both sides of the staple exit slot (26).

2. Stapler according to claim 1, wherein the inside surfaces (34) of the prongs (32), which surfaces face one another, align with a delimitation surface (36) that delimits the staple exit slot (26), in each instance.

3. Stapler according to claim 2, wherein the inside prong surfaces (34) have a distance from one another that essentially corresponds to the width of a staple.

4. Stapler according to claim 1, wherein the prongs (32) come to a point in the direction toward the anvil arm (12).

5. Stapler according to claim 4, wherein the prongs (32) have a triangular cross-section in the direction transverse to the side walls (30) of the staple magazine (20).

6. Stapler according to claim 1, wherein the staple magazine (20) is configured as a bent part having a stop plate (28) formed on in one piece.

7. Stapler according to claim 1, wherein the prongs (32) are formed onto the side walls (30) of the staple magazine (20), in one piece.

8. Stapler according to claim 1, wherein the staple magazine (20) has a magazine head that has the stop plate (28) and the prongs (32) and is connected with the side walls (30), which head closes the staple exit slot (26) off on the sides.
